(19) United States
(12) Patent Application Publication
(10) Pub. No.: US 2015/0325129 A1
(43) Pub. Date: Nov. 12, 2015

(54) METHOD FOR GEO-LOCATING RAW DATA EXCHANGED DURING AN AIR/GROUND TRANSMISSION AND A CORRESPONDING GEO-LOCATION DEVICE

(71) Applicant: ALTYS TECHNOLOGIES, Toulouse (FR)

(72) Inventors: Alexandre Simonin, Toulouse (FR); Kanaan Abdo, Toulouse (FR); Fathia Ben Slama, Toulouse (FR)

(21) Appl. No.: 14/458,253

(22) Filed: Aug. 13, 2014

(30) Foreign Application Priority Data
Aug. 14, 2013 (FR) 1358009

(51) Int. Cl. G08G 5/00

(52) U.S. Cl. CPC G08G 5/0013; G08G 5/0082

(57) ABSTRACT

A method for geo-locating the raw data exchanged between an aircraft and a VHF receiver is provided. Each item of raw data includes an identifier of the aircraft transmitting this item of data. The method includes obtaining position data of the aircraft. In this regard, the position data includes a piece of information which represents the identifier of the aircraft. The method also includes correlating the raw data and the position data by determining the data that has an identical identifier.

### CROSS REFERENCE TO RELATED APPLICATIONS

This application claims priority under 35 U.S.C. §119(a) to French Patent Application Serial Number 1358009, filed Aug. 14, 2013, entitled “METHOD FOR GEO-LOCATING RAW DATA EXCHANGED DURING AN AIR/GROUND TRANSMISSION AND A CORRESPONDING GEO-LOCATION DEVICE”, the entire teachings of which are incorporated herein by reference.

### BACKGROUND OF THE INVENTION

1. Field of the Invention

The invention relates to a method for geo-locating raw data exchanged between an aircraft and a ground receiver, in particular a VHF receiver. The invention also relates to a geo-location device which uses such a method.

2. Description of Related Art

During aircraft navigation, a number of data are exchanged between the aircraft and stations on the ground. These data are, for example, traffic data, status data of aircraft systems or communications between pilots and air-traffic controllers.

These data are exchanged on the very high frequency band (VHF) determined by the range 117.975-137 MHz.

In the following text, all of these data are referred to using the term “raw data” transmitted by an aircraft. Each item of raw data is associated during its transmission by the aircraft with a piece of information representing an identifier of the aircraft. This identifier is generally contained in an ICAO 24 bit address which is unique for each aircraft.

In this manner, it is possible on receiving an item of raw data to determine the aircraft which has transmitted this item of data.

However, it is not currently possible to know precisely where the plane is when it transmitted the raw data, unless, which is rarely the case, the transmitted data comprises a specific field which indicates the position of the plane obtained, for example, by a GPS module mounted on-board the aircraft.

If the aircraft does not comprise such a module or the raw data does not incorporate this information, it is not possible on the ground to know precisely the position of the aircraft when the raw data are transmitted.

There is further a need to know the position of an aircraft when raw data are transmitted. This is because these positions are necessary to be able to carry out diagnostics of air/ground transmissions, in order to improve the performance of these transmissions and the different devices used in the context of these transmissions, and to detect and prevent coverage faults in the implementations which are already deployed.

### BRIEF SUMMARY OF THE INVENTION

The invention is intended to provide, in at least one embodiment of the invention, a method for geo-locating raw data exchanged between an aircraft and a VHF receiver which allows the position of the aircraft which has transmitted the raw data received on the ground to be determined.

The invention is also intended to provide, in at least one embodiment of the invention, such a method which can be adapted to different aircraft (commercial, private or military aeroplanes) and to the different types of signal available on-board these aircraft.

The invention is also intended to provide, in at least one embodiment, a geo-location device for raw data exchanged between an aircraft and a VHF ground receiver.

To this end, the invention relates to a method for geo-locating the raw data exchanged between an aircraft and a VHF receiver, each item of raw data comprising an identifier of the aircraft transmitting this item of data.

A method according to the invention is characterised in that it comprises:

a step of obtaining position data of the aircraft comprising a piece of information which represents the identifier of this aircraft,

a step of correlating the raw data and the position data by determining the data which have an identical identifier.

A method according to the invention therefore allows information to be acquired which represents the identifier of the aircraft and each item of raw data to be associated with an item of position data by cross-referencing the raw data and the position data which comprise the same identifier. A method according to the invention therefore allows a position of the plane when this item of data is transmitted to be attributed to each item of raw data received. A method according to the invention therefore allows the geo-location of the raw data exchanged during a transmission between an aircraft and a VHF reception station.

The identifier of the aircraft may, for example, be the 24 bit identifier which is supplied by the International Civil Aviation Organisation (more commonly known as ICAO) or the registration number of the aircraft or any similar information which allows an aircraft to be identified.

According to a variant of the invention, the information which represents the identifier of the aircraft is the 24 bit identifier supplied by the ICAO. Such a 24 bit ICAO identifier is unique for each aircraft and therefore allows the raw data to be correlated directly with the position data which comprise such an identifier. This variant is particularly suitable for the case in which the identifier of the aircraft is directly available on the ground. This is the case, for example, when the aircraft is equipped with the cooperative surveillance system for the control of air traffic known as ADS-B (automatic dependent surveillance-broadcast) and the corresponding signals are received and available on the ground.

According to another variant of the invention, the information representing the identifier is a registration number of the aircraft. According to this variant, the method further comprises a step of recovering the ICAO identifier of the aircraft by consultation of a database which connects aircraft identifiers with the registration numbers of aircraft. This variant is particularly suitable for the case in which the only information available is the registration number of the aircraft. This is the case, for example, when the aircraft is provided only with the radio communication system known as ACARS (aircraft communication addressing and reporting system) or the communication mode used by the aircraft at the time of transmission is the ACARS mode, or only the corresponding signals are received and available on the ground.

A geo-location method according to the invention further enables the transmission power of the signals which carry the raw data to be determined. In particular, it is generally possible to know the reception power of the signals on the ground. The invention enables the precise position of the source to be known at the time at which the signals are transmitted. Therefore, the transmission power of the signals can be derived from the knowledge of the reception power and the geo-location of the data obtained by a method according to the invention. The transmission power is intended, in accordance with standards, to be constant. A method according to the invention, owing to the large number of recordings which can be obtained thereby, can therefore contribute to determining, where applicable, whether an observed variation of the transmission power is the result of either a non-standard transmitter or a coverage problem.

Advantageously and according to the invention, the step of obtaining position data of the aircraft comprises a step of receiving the data which are transmitted by the aircraft on a channel which is dedicated to the transmission of position data.

Such a dedicated channel is, for example, a dedicated channel of the above-mentioned cooperative surveillance system ADS-B. According to a variant, it is the channel known under the name 1090 ES (1090 MHz extended squitter). According to another variant, it is the channel known by the acronym UAT (universal access transponder). According to another variant, it is the channel known by the acronym VDL mode 4 (VHF data link mode 4). According to another variant, it is the channel known by the acronym GBAS (ground-based augmentation system).

Advantageously and according to the invention, the step of obtaining position data of the aircraft comprises:

a step of receiving, at non-predetermined times, position information of the aircraft transmitted by the aircraft,

a step of extrapolating the position of the aircraft during the transmission of the raw data from the position information obtained.

According to this variant, the precise position of the aircraft is known only at non-predetermined times and therefore does not allow the position of the aircraft to be defined immediately when raw data is transmitted. Therefore, the invention provides according to this variant for a step of extrapolating the position of the aircraft from the positions which are known and already received. This extrapolation may be of any type. It may be a linear extrapolation, an extrapolation of the Béziers type or any other method of extrapolation. The principle is to determine the position of the aircraft at a time t depending on the knowledge of at least two positions at times close to the time t being considered. This variant is particularly suitable when the only available information about the position of the aircraft is information which is sometimes provided on a channel known by the acronym VDL-2 (VHF data link, mode 2) or during an ACARS communication, or when the dedicated channels of the ADS-B system are only partially operational and only specific position information is received. That is to say, this variant allows the position of the aeroplane to be reconstituted from knowledge of some positions of the aeroplane received at random and non-systematic times. It is therefore particularly suitable for all types of aircraft, including private planes which are not generally provided with ADS-B systems.

In combination and according to a variant, the pieces of position information received at non-predetermined times are pieces of flight intention information of the aircraft transmitted by the aircraft either on the transmission channel or on a dedicated channel. Such information is, for example, available in ADS-C messages, in pilot requests and associated controller authorisations (CPDLC exchanges), or in updated flight plans (exchanged between an aircraft and the company which operates it), or in XID messages when the aircraft transmits in a VDL2 mode. A method according to this variant therefore allows, only from flight intention information, the data received on the ground to be geo-located.

Advantageously, a method according to the invention further comprises:

a step of time-stamping each item of raw data received by the receiver,

a step of time-stamping each item of position data obtained.

Advantageously and according to this variant, the step of correlating the raw data and position data involves determining the data which have an identical identifier and time-stamp.

A method according to this variant therefore comprises:

a step of time-stamping each item of raw data received by the receiver,

a step of obtaining position data of the aircraft comprising information which represents an aircraft identifier,

a step of time-stamping each item of position data obtained,

a step of correlating the raw data and position data by determining data which have an identical identifier and an identical or similar time-stamp.

This variant of the invention allows the raw data received by the receiver and position data to be time-stamped. In this manner, the step of correlating data is more precise and cross-references not only the identifiers of the aircraft, but also the time-stamps of the data. This reinforces the robustness of the correlation step. Furthermore, it enables the time to be known at which the raw data and/or the position data were transmitted by the aircraft and/or received by the receiver.

According to a variant of the invention, the time-stamping of the position data and the raw data is obtained via independent sources. According to another variant, the time-stamping of an item of position data is calculated from the knowledge of the time-stamping of the item of raw data and the position of the aeroplane at the time at which this item of position data is sent. That is to say, the step of time-stamping each item of position data received comprises a step of extrapolating the time-stamping of the item of raw data received. This in particular allows any absence of information about time-stamping of data positions to be overcome. According to another variant or in combination, the time-stamping of the item of raw data is directly provided with the item of raw data by the transmitter.

Advantageously and according to the invention, the step of time-stamping each item of raw data received comprises a step of receiving GPS data by a GPS receiver in order to time-stamp this item of data. According to another variant, the time-stamping of the data may be obtained by means of a time server or any equivalent means.

Advantageously, a method according to the invention further comprises a step of complementing a position database of the aircraft.

The database comprises all of the position information of the aircraft obtained by a method according to the invention.

It is possible to interrogate this database in order to recover all the position data of the aircraft. In particular, the interrogation of this database allows the recovery of each item of raw data which is associated with the position of the aircraft at the time of the transmission and/or reception of this item of raw data, the corresponding time-stamp, where applicable, and the identifier of the aircraft.

A method according to the invention therefore enables the geo-location of all the raw data exchanged during an air/ground transmission between an aircraft and a VHF receiver. It also allows the raw data to be complemented with time-stamp information, position information of the aircraft and pieces of information which characterise the aircraft, in particular the ICAO 24 bit identifier thereof.

The invention also relates to a device for geo-locating raw data exchanged between an aircraft and a receiver, each item of raw data comprising an identifier of the aircraft which transmits this item of data.

A geo-location device according to the invention is characterised in that it comprises:

a module for obtaining position data from the aircraft comprising information which represents the identifier of this aircraft,

a module for correlating the raw data and position data by determining the data which have an identical identifier.

The modules may be used by analogue means or digital means or a combination of analogue and digital means.

According to a variant, the device according to the invention comprises an antenna for receiving the raw data, an antenna for receiving position data and an antenna for receiving time-stamp information of the data received. It further comprises a VHF receiver for raw data which is connected to the reception antenna.

A geo-location device according to the invention advantageously carries out a method according to the invention and a method according to the invention is advantageously carried out by a device according to the invention.

The invention also relates to a method for geo-locating raw data exchanged between an aircraft and a VHF receiver, to a geo-location device for raw data exchanged between an aircraft and to a VHF receiver, characterised in combination by all or some of the above or below mentioned features.

### BRIEF DESCRIPTION OF THE DRAWINGS

Other objectives, features and advantages of the invention will be appreciated from a reading of the following description, given purely by way of non-limiting example, and with reference to the appended drawings, in which:

FIG. 1 is a schematic view of a geo-location method according to an embodiment of the invention,

FIG. 2 is a schematic view of a geo-location method according to another embodiment of the invention,

FIG. 3 is a schematic view of a geo-location device according to an embodiment of the invention.

### DETAILED DESCRIPTION OF EMBODIMENTS OF THE INVENTION

According to the invention, a method for geo-locating raw data 4 exchanged between an aircraft 7 and a receiver comprises a step 10 for obtaining position data 5 of the aircraft 7 and a step 11 for correlating the raw data 4 and position data 5 by determining the data which have an identical identifier 6. According to the invention, each item of position data 5 of the aircraft 7 comprises information which represents the identifier 6 of this aircraft 7.

The exchanged raw data 4 may be of any type. They are, for example, traffic data, status data of aircraft systems or communications between pilots and air-traffic controllers. These data are generally exchanged on the very high frequency band (VHF) determined by the range 117.975-137 MHz. The data may be received on a single communication channel at predetermined frequencies or on a plurality of communication channels.

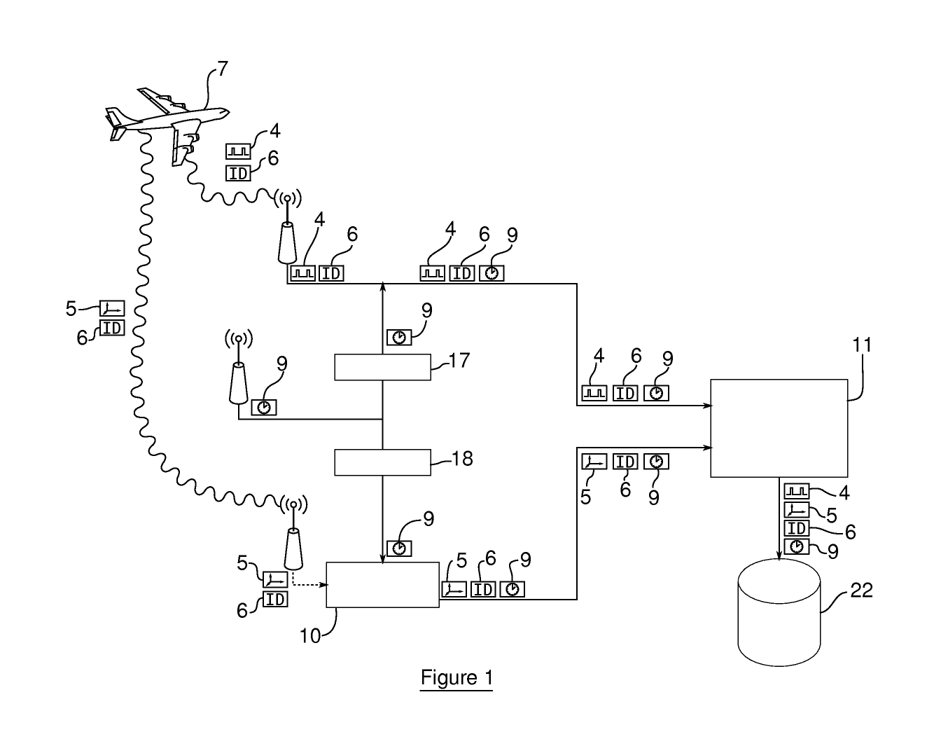

According to an embodiment of the invention, and as illustrated in FIG. 1, the information which represents the identifier 6 of the aircraft is a 24 bit identifier which is supplied by the International Civil Aviation Organisation.

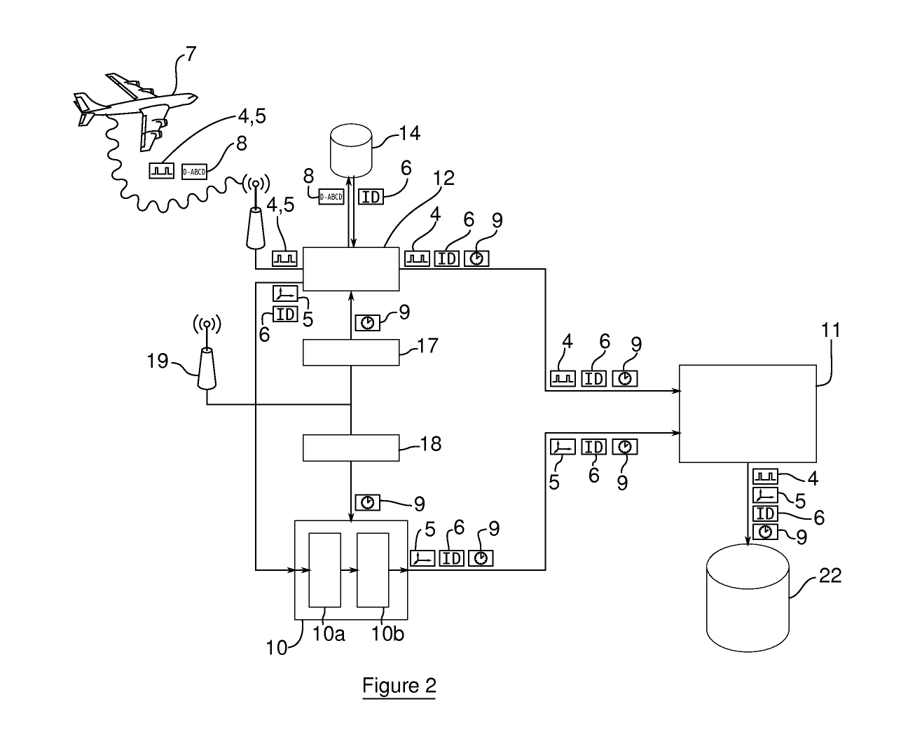

According to another embodiment of the invention and as illustrated in FIG. 2, the information which represents the identifier 6 is a registration number 8 of the aircraft 7. In this instance, the method comprises a step 12 of recovering the identifier 6 of the aircraft 7 by consultation of a database 14 which connects the identifiers of aircraft with the aircraft registration numbers. This database 14 is, for example, the one which is available from the official website of the ICAO (http//:www.icaodata.com) or the one of the English Civil Aviation Authority (http://www.caa.co.uk/default.aspx?catid=122&pageid=8759) or the database which is accessible via the site http://www.airframes.org/.

In FIG. 1 and for the sake of clarity, the raw data 4 and the identifier 6 have been illustrated as two separate items of data whilst, in practice, they form a single item of data and are transmitted by the same signal between the aircraft and the receiver. In the same manner, in FIG. 2, the registration number 8 and the raw data 4 form a single item of data, but have been illustrated as two separate items of data in order to facilitate understanding of the invention.

The selection of the embodiment is dependent on the communication between the aircraft and the receiver. If it is an ACARS communication, only the registration of the aircraft is contained in the flow of data exchanged. The embodiment in FIG. 2 is therefore to be preferred in this instance. However, if it is a VDL2 communication, the identifier is directly available so the embodiment in FIG. 1 is to be preferred.

With regard to receiving position data 5, two main embodiments may be envisaged and are dependent on the type of communication between the aircraft and the receiver and the type of data exchanged during this communication.

According to a first embodiment of the invention and as illustrated in FIG. 1, the step 10 of obtaining position data of the aircraft 7 comprises a step of receiving the data transmitted by the aircraft 7 on a dedicated channel, such as a channel 1090ES or a UAT channel. Such a channel provides position information of the aircraft at regular intervals, generally every second.

According to a second embodiment and as illustrated in FIG. 2, the step 10 of obtaining position data of the aircraft 7 comprises a step 10a of receiving at non-predetermined times, position information of the aircraft and a step 10b of extrapolating the position of the aircraft 7 during transmission of the raw data from the position information obtained. In FIG. 2, the position data 5 are derived directly from the raw data 4. This embodiment is particularly suitable for the case in which the only available information about the position of the aircraft is information which is contained directly in the raw data 4, but only at specific times, so that the position of the aircraft 7 is not directly accessible for all the raw data. If the item of raw data contains an item of position information, then the item of raw data contains its own geo-location information. If the item of raw data does not contain any position information, step 10a of receiving at non-predetermined times position information of the aircraft and step 10b of extrapolating the position of the aircraft 7 allow the position information to be recovered. This is particularly the case when the raw data received are data which are exchanged during an ACARS or VDL2 communication. The extrapolation step 10b involves determining the position of the aircraft 7 at a time t depending on the knowledge of the position of the aeroplane at least at two times t1, t2 which are close to t. Different methods may be used to determine the position of the aircraft at the time t. These may, for example, be a linear extrapolation or a Béziers extrapolation or any equivalent method. These methods are widely discussed in literature and are known to the person skilled in the art, and are not therefore described here in detail.

According to the embodiment in the drawings, the method further comprises a step 17 of time-stamping each item of raw data 4 received by the receiver and a step 18 of time-stamping each item of position data 5 obtained. This time-stamping is obtained via a reception 19 of GPS data. Of course, according to other embodiments, the time-stamping of the data may be obtained using other technical means, for example, by consultation of a time server of the NPT type or the like.

A method according to the invention therefore allows each item of raw data 4 received to be geo-located by providing, at the output of the method, raw information 4, the position 5 of the aircraft at the time of transmission of this item of raw data 4, the identifier 6 of the aircraft 7 having transmitted this item of raw data 4, and the time 9 at which this item of raw data 4 was transmitted. All of this information is stored in a database 22 which may act as a knowledge base, interrogation base or bases for statistical analysis in order to evaluate the performance levels of the air/ground transmissions in particular.

Each of the steps of the method according to the embodiments described may be carried out using software means, analogue means or a combination of software and analogue means. In particular, the correlation step 11 is preferably carried out by a computer and by means of modules which can be implemented within this computer. The step 10 of obtaining position data is preferably carried out by a combination of analogue means, for example, an antenna for receiving data transmitted by an aircraft, and software means, for example, a computer which allows the data received to be processed and transmitted to the means which carry out the correlation step 11.

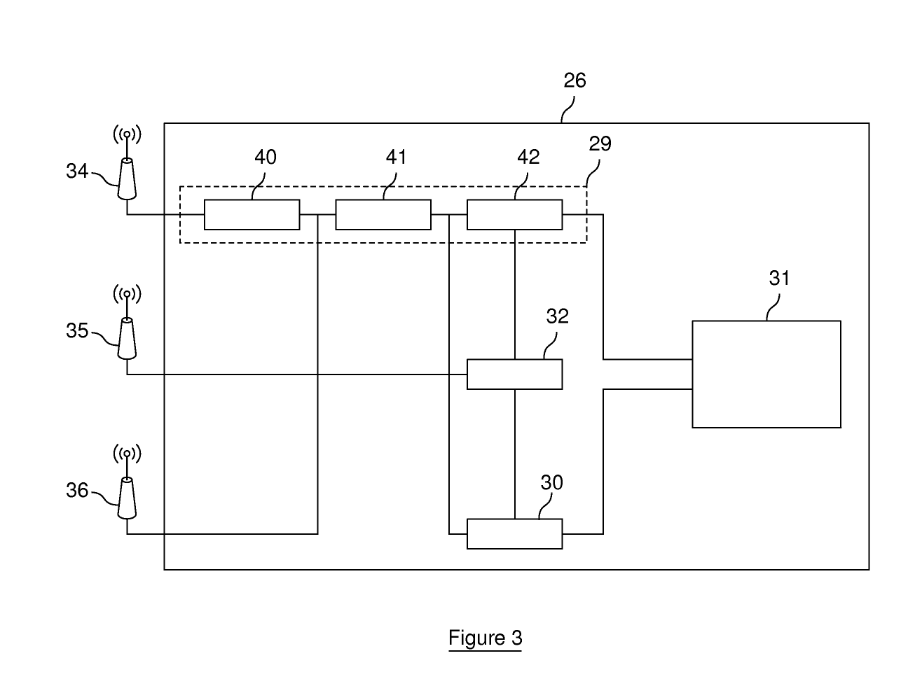

The invention also relates to a device 26 for geo-locating raw data exchanged between an aircraft 7 and a receiving station on the ground. FIG. 3 is a schematic view of such a device according to an embodiment of the invention.

According to the embodiment in the drawings, the geo-location device 26 comprises a raw data receiver 29 which is connected to a reception antenna 34. This receiver 29 is a VHF receiver. Such a receiver is a single-channel receiver according to an embodiment of the invention. According to another embodiment, it is capable of simultaneously receiving a plurality of communication channels. According to the embodiment in FIG. 3, it comprises a pass-band filter 40 which is capable of filtering the signal received and retaining only specific frequencies thereof. The signal then passes via a software radio module 41, more commonly known by the acronym SDR. This module 41 samples and digitises the signal received and transmits it to an extraction and demodulation module 42. This module 42 is capable of providing the raw data 4 to be sent to the correlation module.

The geo-location device also comprises a module 30 for obtaining position data of the aircraft 7. Such a reception module 30 is, for example, a 1090 ES or UAT receiver capable of receiving position data of the aircraft. According to the embodiment in the drawings, the module 30 is connected to the SDR module 41 of the VHF receiver, which is itself supplied by the signals received via a 1090ES or UAT signal reception antenna 36. This configuration is particularly advantageous since it allows several signals of a different type to be processed by the same SDR module 41. This being the case, in other embodiments, the signal received by the antenna 36 is directly transmitted to the module 30 for obtaining position signals, optionally after processing by an SDR module specifically dedicated to these signals. In the embodiment in FIG. 3, the position signal which contains the position data is received by the antenna 36, then passes via the SDR module 41, before being processed by the module 30, which will extract the position data. The extracted data are then supplied to the correlation module 31 in order to allow the geo-location of the raw data provided by the receiver 29.

The geo-location device 26 further comprises a data time-stamping module 32. This time-stamping module 32 is, for example, a GPS receiver which is connected to an antenna 35 for receiving GPS signals. According to another embodiment, this module 32 is connected to a time server which is capable of providing a precise date and time.

Each of the modules of a geo-location device 26 according to the invention may comprise analogue means, software means or a combination of analogue and software means. Preferably, the modules are implemented by software means, either on the same machine, or distributed over a plurality of machines. In particular, the modules can communicate with each other via a TCP-IP communication.

The geo-location device 26 has been described in connection with FIG. 3 as comprising the receiver 29 for raw data. This embodiment is particularly advantageous since it allows the signals to be received and geo-located via a single device.

This being the case, in another embodiment, the geo-location device is independent of the receiver 29 for raw data and comprises only a module for receiving position signals and a correlation module. Such a device may, for example, be implemented via software means and receives at the input the raw data and the digitised position data and provides at the output a correlation between the data which has an identical identifier and an identical time-stamp where applicable. Such a geo-location device may advantageously be associated with known receivers in order to supplement them with a new functionality for geo-locating the raw data received.

The invention is not limited to the described embodiments. In particular, in accordance with at least one other embodiment and based on the embodiment in FIG. 2, the raw data received which also acts as an item of position data may directly contain an identifier of the aircraft so that the step of recovering the identifier from the registration number of the aircraft is not necessary. Other variants are also possible and are dependent on the type of signals available on the ground and the content of these signals.

1. A method for geo-locating raw data exchanged between an aircraft and a very high frequency (VHF) receiver, each item of raw data comprising an identifier of the aircraft transmitting this item of data, the method comprising:
obtaining position data of the aircraft the data comprising a piece of information which represents the identifier of the aircraft,
correlating the raw data and the position data by determining the data which have an identical identifier.

2. The method according to claim 1, wherein the information which represents the identifier of the aircraft is a twenty-four (24) bit identifier supplied by the International Civil Aviation Organisation.

3. The method according to claim 1, wherein the information representing the identifier is a registration number of the aircraft, the method further comprising recovering the identifier of the aircraft by consultation of a database which connects aircraft identifiers with registration numbers of aircraft.

4. The method according to claim 1, wherein obtaining position data of the aircraft comprises receiving the position data as transmitted by the aircraft on a dedicated channel.

5. The method according to claim 4, wherein the dedicated channel is a channel selected from the group consisting of a 1090 ES channel, a UAT channel and a GBAS channel.

6. The method according to claim 1, wherein obtaining position data of the aircraft comprises:
receiving, at non-predetermined times, position information of the aircraft transmitted by the aircraft;
extrapolating the position of the aircraft during the transmission of the raw data from the obtained position information.

7. The method according to claim 6, the position information received at non-predetermined times include flight intention information of the aircraft transmitted by the aircraft.

8. The method according to claim 1, further comprising:
time-stamping each item of raw data received by the VHF receiver, and
time-stamping each item of obtained position data.

9. The method according to claim 8, wherein correlating the raw data and position data comprises determining the data that has an identical identifier and time-stamp.

10. The method according to claim 8, wherein time-stamping each item of received raw data comprises receiving global positioning system (GPS) data by a GPS receiver in order to time-stamp each item of received raw data.

11. The method according to claim 8, wherein time-stamping each item of obtained position data comprises extrapolating a time-stamp from the item of raw data received by the VHF receiver.

12. The method according to claim 8, further comprising complementing a position database of the aircraft.

13. A device for geo-locating raw data exchanged between an aircraft and a receiver, each item of raw data comprising an identifier of the aircraft which transmits the item of raw data, the device comprising:
a computer with memory and at least one processor;
a module executing in the memory and obtaining position data of the aircraft comprising information which represents the identifier of this aircraft,
a module executing in the memory and correlating the raw data and position data by determining the data which have an identical identifier.
